(19) United States
(12) Patent Application Publication
(10) Pub. No.: US 2026/0297265 A1
(43) Pub. Date: Oct. 1, 2026

(54) ZWITTERION-CONTAINING ADDITIVE FOR SURFACE FUNCTIONALIZATION OF MATERIALS

(71) Applicants: Trustees of Tufts College, Medford, MA (US); The General Hospital Corporation, Boston, MA (US)

(72) Inventors: Ayse Asatekin Alexiou, Arlington, MA (US); Luca Mazzaferro, Boston, MA (US); Ayse Aslihan Gokaltun, Chestnut Hill, MA (US); Osman Berk Usta, Andover, MA (US); Ryan O'Hara, Somerville, MA (US)

(21) Appl. No.: 19/490,068

(22) PCT Filed: Jun. 10, 2024
(86) PCT No.: PCT/US2024/033229

§ 371 Date: Dec. 4, 2025

Related U.S. Application Data
(60) Provisional application No. 63/472,039, filed on Jun. 9, 2023.

(51) Int. Cl. C08G 77/452; B01L 3/00

(52) U.S. Cl. CPC C08G 77/452; B01L 3/5027; B01L 2300/12

(57) ABSTRACT

Disclosed are zwitterion-containing copolymers and their use for creating functional surfaces on silicone-based materials. These copolymers are blended with silicone precursors at low concentrations before curing. The chemical structure of the copolymer additive leads it to segregate to the surface particularly upon contact with polar or aqueous media.

### RELATED APPLICATION

This application claims the benefit of priority to U.S. Provisional Application No. 63/472,039, filed Jun. 9, 2023.

### GOVERNMENT SUPPORT

This invention was made with government support under grants HL145031, GM136002, and GM141683 awarded by the National Institutes of Health and grants 1904465 and 22342435 awarded by the National Science Foundation. The government has certain rights in the invention.

### BACKGROUND

The use of microfluidics in biomedical research through tissue culture experiments and biological separations is growing rapidly. Polydimethylsiloxane (PDMS) has been the most popular material for microfluidics due to its feature replication down to the nanoscale, flexibility, gas permeability for oxygenation, and low cost. Yet, the hydrophobicity of PDMS leads to the adsorption of macromolecules and small molecules on device surfaces. This curtails its use in “organs-on-chip” and other applications. Current technologies to improve PDMS surface hydrophilicity involve added processing steps and/or do not create surfaces that remain hydrophilic for long periods.

### SUMMARY

In one aspect, disclosed are copolymers comprising a plurality of zwitterionic repeat units, and a plurality of second repeat units; wherein each second repeat unit comprises a poly(dialkyl siloxane) pendant group.

In another aspect, disclosed is a sample of polydimethylsiloxane comprising the copolymer disclosed herein.

In yet another aspect, disclosed is a microfluidic device comprising the polydimethylsiloxane disclosed herein.

### BRIEF DESCRIPTION OF THE DRAWINGS

FIG. 1 Zwitterionic Copolymer Addition for Modifying PDMS Surfaces. We blend PDMS prepolymer and highly branched zwitterionic copolymers (ZI CPs), and fabricate the PDMS using the standard procedures (without added steps). ZI CPs segregate to the PDMS surface in the air. ZI groups cover the surface after surface rearrangement occurs in the presence of aqueous solutions. Thus, we can prevent nonspecific molecule adsorption & absorption.

FIG. 2 ¹H-NMR spectrum of the random PDMSMA-r-MPC copolymer. PDMSMA:MPC (w/w %):70/30.

FIG. 3 PDMS blended with PDMSMA-r-MPC zwitterionic copolymers decreases hydrophilicity. FIG. 3A shows photographs and FIG. 3B is a chart of water contact angle (WCA) and stability of PDMS samples blended with PDMSMA-r-MPC copolymer ratios between 0.025%-0.25% at different time intervals. Before measurement, we soaked the samples in IPA for 24 hours and treated them with O₂ plasma. Measurements were taken a week after O₂ treatment. PDMSMA/MPC (w/w %): 70/30. The data are the mean±SE (N=3). We use ***: p≤0.001 by Tukey-test for significance comparisons between the controls and modified PDMS groups.

FIG. 4 The transparency of PDMS with PDMSMA-r-MPC CP. (a) before and b) after IPA soaking between 400-600 nm. We did not observe a significant difference in the transmittance values of the blended samples before soaking them in IPA. After IPA soaking, the transparency of PDMS with 0.25% PDMS-r-MPC additive slightly decreased. PDMSMA/MPC (w/w %): 70/30. The data are the mean±SE (N=3). Standard error bars are in between (0.001-0.005) and are smaller than the size of markers.

FIG. 5 PDMS with PDMSMA-r-MPC CP demonstrates similar CO₂ and O₂ permeability compared to PDMS control. Permeability tests were performed without any treatment to samples (no IPA soaking and plasma treatment). PDMSMA/MPC (w/w %): 70/30. The data are the mean±SE (n=3). We use n.s.: non-significant, **: p≤0.01 by Tukey-test for significance comparisons between the controls and modified PDMS groups.

FIG. 6 PDMS with PDMSMA-r-MPC CP drastically reduces protein adsorption and dye absorption. Protein adsorption and dye absorption of un/modified PDMS (0.025-0.25%) samples. Fluorescently tagged albumin and lysozyme adsorption onto CP modified PDMS slabs FIG. 6A without treatment, FIG. 6B after IPA soak and 1 week following O₂ plasma. Protein solutions were applied to the samples for 30-90 minutes. Image scale bar: 400 μm. Normalized fluorescence intensity of albumin and lysozyme, FIG. 6C without treatment, FIG. 6D after IPA soak and 1 week following O₂ plasma. Vitamin B12 and reactive red absorption of un/modified PDMS FIG. 6E without treatment, FIG. 6F after IPA soak and 1 week following O₂ plasma. PDMS/MPC (w/w %): 70/30. The data are the mean±SE (N=3). ***: p≤0.001 by Tukey-test for significance comparisons between the controls and modified PDMS groups.

FIG. 7 Final (t=45) WCA comparison of PDMS with PDMSMA-r-MPC (0.025%-0.25 w/w %) before IPA soaking (BS), after IPA soaking (AS). PDMS prepolymer blended with PDMS:MPC ratio of FIG. 7A 60/40 (CB-6), FIG. 7B 70/30 (CB-7), and FIG. 7C 80/20 (CB-8). The data are the mean±SE (N=3). n.s. (non-significant) difference obtained between the controls and modified PDMS groups by Tukey-test for significance comparisons.

FIG. 8 Water contact angle (WCA) of PDMS samples blended with FIG. 8A 60/40 and FIG. 8B 80/20 PDMSMA-r-MPC (0.025%-0.25 w/w %) after IPA soaking and 1 week after O₂ plasma (AS+PT+1 wk) at different time intervals. The data are the mean±SE (N=3).

FIG. 9 ¹H-NMR spectrum of the random PDMSMA-r-MPC-r-HEMA copolymer. PDMSMA MPC HEMA 60:30:10 (w/w %).

FIG. 10 ¹H-NMR spectrum of the random PDMSMA-r-MPC-r-HEMA copolymer. PDMSMA MPC HEMA 60:20:20 (w/w %).

FIG. 11 ¹H-NMR spectrum of the random PDMSMA-r-MPC-r-MAA copolymer. PDMSMA MPC MAA 60:30:10 (w/w %).

FIG. 12 Water contact angle measurements of PDMS samples blended with PDMSMA-r-MPC-r-HEMA and PDMSMA-r-MPC-r-MAA copolymers.

FIG. 13 Congo Red functionalization of PDMS samples blended with PDMSMA-r-MPC-r-HEMA.

FIG. 14 Images comparing fouling of samples of PDMS comprising copolymers of the invention under bright field and by GFP fluorescence.

FIG. 15A chart comparing fouling of samples of PDMS comprising copolymers of the invention by relative normalized fluorescence.

FIG. 16 PDMS and the smart, zwitterionic (ZI) branched copolymers (CPs) are blended, and device is fabricated following usual processes (no added steps). CPs segregate to the PDMS surface in air. When in contact with water, surface rearrangement creates a surface covered with ZI groups that prevent non-specific adsorption of proteins and drugs. The copolymers can also contain functional groups such as peptides or binding sites, allowing further customization in a single step.

FIG. 17 Smart CP architectures for antifouling and functionalization.

FIG. 18 Smart CP comprising PDMS branches with both ZI and binding groups is blended with PDMS during fabrication. Surface segregation and rearrangement creates a dual functional surface featuring specific binding sites (e.g., biotin, galactosamine) in a matrix of fouling-resistant ZI groups. This selectively promotes binding of desired species (e.g., proteins, cells) while still inhibiting non-specific adsorption.

### DETAILED DESCRIPTION

The present disclosure describes a novel, simple, fast, and scalable method for preventing the nonspecific adsorption of proteins and small molecules on PDMS through the use of a surface-segregating highly branched zwitterionic copolymer as an additive that is blended in during manufacture. These copolymers spontaneously segregate to surfaces and rearrange in contact with aqueous solutions to resist nonspecific adsorption. Mixing with a tiny proportion (0.025% w/w) of the highly branched zwitterionic copolymer in bulk PDMS considerably reduced hydrophobicity and nonspecific adsorption of proteins (albumin and lysozyme) and small molecules (vitamin B12 and reactive red). Modified PDMS surfaces combine dual surface properties (i.e., hydrophobic or hydrophilic surfaces with adsorption resistance) depending on treatments after manufacture (e.g., O₂ plasma). Moreover, modified PDMS retains its mechanical and physical properties for at least six months. The method is fully compatible with existing PDMS device manufacture protocols without additional processing steps. Thus, these modified PDMS samples will improve the accessibility of microfluidics to end-users (patients, researchers, drug industry) by providing a low-cost and user-friendly approach to fabricating reliable biomicrofluidics.

The microfluidics market grossed $20.7 billion in 2019 and is estimated to reach $59 billion by 2026, propelled by point-of-care diagnostics, pharmaceutical & life science research, and therapeutics. Poly(dimethyl siloxane) (PDMS) is one of the most widely used materials for biomicrofluidics due to its 1) chemical inertness, 2) high gas permeability, 3) flexibility, 4) optical clarity from 240 to 1100 nm, 5) low cost, 6) biocompatibility, and 7) feature reproduction. PDMS allows rapid prototyping and, upon plasma oxidation, can adhere to itself or other materials without adhesives. However, the hydrophobicity of PDMS (water contact angle, WCA, ~108°) often limits its biomedical applications due to the nonspecific adsorption of proteins and absorption of small hydrophobic molecules. This leads to the loss of active compounds, influences analyte transport, and affects separation performance and detection sensitivity. These limitations complicate quantitative analysis in proteomics, genomics, and cell-based assays.

An efficient method for creating hydrophilic, fouling-resistant surfaces without added manufacturing steps involves mixing surface-segregating copolymers with the bulk commodity polymer material. Devices are then fabricated following the standard protocol. During the manufacturing process, these smart copolymers spontaneously segregate to surfaces and create a <1 nm layer when in contact with aqueous solutions that prevent nonspecific adsorption/absorption of organic molecules. This approach has been applied successfully to reduce fouling in membranes and acrylic biomaterials. In our previous work, we showed that surface-segregating commercial PDMS-PEG block copolymers could lower the WCA of PDMS down to ~10°, suppress protein adsorption, and create more stable hydrophilicity for at least 20 months. Another group tested a similar copolymer and strategy to prevent drug absorption. Although promising results were obtained, PDMS with PDMS-PEG block copolymer needed to be pretreated with various dosages of drugs for a week to reduce drug absorption. This shows PEG's limitations in some applications. Although PEG has been the gold standard for preventing non-specific protein adsorption in many fields, its polyether backbone is comparatively non-polar. Most PEG-based coatings also include a relatively hydrophobic —O—CH₃ terminal group, needed to ensure stability and prevent depolymerization. As a result, PEG interacts with many compounds via hydrogen bonding and hydrophobic interactions. This interaction limits PEG's fouling resistance in complex mixtures.

PEG's limitations led us to seek other anti-fouling chemistries to create more stable and fouling-resistant surfaces. Zwitterionic (ZI) groups, defined by equal numbers of anionic and cationic moieties, are extremely fouling-resistant and offer crucial advantages over PEG. The super-hydrophilicity of ZI groups prevents ZI-protein interactions, leading to better performance than PEG in complex environments such as blood-contacting microfluidic devices and in vivo studies. Unlike PEG, ZI groups are incompatible with most organic solvents and small organic molecules. This implies their preference to interact with water over small organic molecules, reducing their adsorption on PDMS surfaces and curtailing their absorption.

Several researchers have focused on modifying PDMS with ZI groups with surface coating strategies by post-processing to improve hydrophilicity and decrease non-specific adsorption. Many of these treatments have led to improved surface hydrophilicity. However, the critical bottleneck to these approaches has been their laborious multiple post-processing steps that require special equipment and complicate large-scale fabrication and adoption by a broad user base. These modifications typically used toxic chemicals that may limit biocompatibility in cell-based microfluidics and often affected PDMS's optical and mechanical properties. Further, while some studies have shown ZI polymers grafted onto PDMS provide a hydrophilic surface for longer than PEO and similar hydrophilic polymers (~3 months), most of the treatments did not show long-term stability, reverting to hydrophobic behavior over a period of days to weeks.

To circumvent these complex post-processing steps, it would be preferable to incorporate ZI groups into the PDMS-based materials during the device processing step, simply blending a ZI components into the prepolymer. There is only one study that simply mixed a zwitterionic component, in this case a ZI monomer, with PDMS pre-polymer during device manufacture to reduce platelet deposition. In this research, the ZI monomer, diallyl terminated sulfobetaine (SB-diallyl), SB-diallyl was dissolved in 1,1,1,3,3,3-hexafluoro-2-propanol (HFIP) and mixed into PDMS. While the modified samples slightly reduced platelet and blood adsorption, they showed similar water contact angles (105.4°) with the unmodified PDMS) (106.4°. Notably, these samples had lower gas permeability and transparency and higher modulus than unmodified PDMS. The optical clarity of PDMS with SB-diallyl decreased with increased additive concentration, whereas the thicker samples were opaque due to phase separation. The use of HFIP also generates a risk of toxicity for long-term cell cultures. These issues highlight the need to develop a practical and advanced modification strategy for PDMS while retaining its key positive attributes. This requires a rational design of a ZI-containing material that will selectively segregate to the device surface, and stay well-integrated in PDMS to avoid issues associated with phase separation (e.g., loss of transparency and transport properties).

As the focus of this invention, we designed and synthesized a zwitterionic copolymer (CP) to create hydrophilic and non-fouling surfaces on PDMS by a simple and scalable method, with no added manufacturing steps and using an extremely small amount of this smart additive to achieve enhanced performance. In one form, this copolymer comprises two types of repeat units: (1) a zwitterionic repeat unit, and (2) a repeat unit with a short pendant chain of silicone (e.g., poly(dimethyl siloxane); PDMS). This additive, when used under appropriate conditions, results in a surface that is comparatively more hydrophilic, and resistant to non-specific adsorption of proteins and other biomacromolecules. In another form, the copolymer can include a third, functionalizable repeat unit that also ends up on the material surface. This group can be used to attach desired groups that would mediate specific adsorption of desired compounds (e.g., specific proteins or cells) while the zwitterionic background protects from non-specific adsorption.

For example, zwitterionic copolymer (CP), poly(polydimethylsiloxane methacrylate-random-2-methacryloyloxyethyl phosphorylcholine) (PDMSMA-r-MPC), was designed to have a branched architecture to enhance the surface segregation of the CP during device manufacture via the entropic driving force for chain ends to occupy interfaces. This branched CP is synthesized using the macromonomer method, by the statistical copolymerization of PDMSMA, which has a PDMS chain attached to a polymerizable group, and the zwitterionic monomer MPC. The polymerizable groups were selected to result in a roughly random arrangement of PDMSMA and MPC units along the backbone, PDMSMA units providing the branches. We prepared blends of PDMS with this CP at concentrations between 0.025-0.25 w/w %. Upon manufacture, the short PDMS sidechains drive the whole polymer to the surface. Upon water immersion, local rearrangement of the CP exposes ZI groups to the surface (FIG. 1). Exemplary ZI monomers include carboxybetaine methacrylate (CBMA), sulfobetaine methacrylate (SBMA), and phosphorylcholine methacrylate (PCMA).

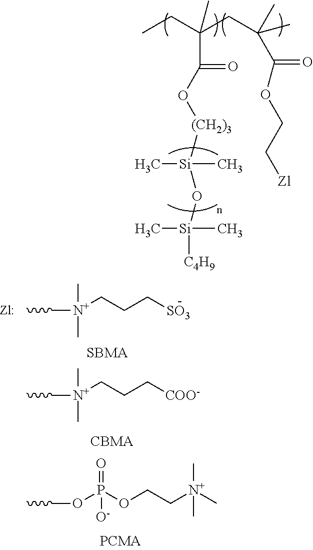

We first evaluated the effect of PDMS chain length and composition on surface segregation via changing PDMS monomer molecular weight and PDMS/MPC monomer ratios. Optimizing these parameters resulted in the segregation of zwitterionic groups to the PDMS surface, as desired. Then, we tested the surface wettability and stability of PDMS with PDMS-r-MPC CP. PDMS-r-MPC CP additives significantly reduced the water contact angle from 102 to 55.8° using as little as 0.025% (w/w) copolymer. This surface hydrophilicity was stable for at least six months. Moreover, using only 0.025 (w/w) % CP additive in PDMS suppressed protein adsorption and small molecule absorption by over 90%. Modified PDMS preserved its physical and mechanical properties compared to additive free PDMS. Our manufacturing method differentiates itself from previous approaches by its simplicity and scalability during both manufacture and use, requiring extremely small concentrations of an easily synthesized additive and no added manufacturing steps. Thus, this method promises a straightforward, rapid, and cost-effective approach to manufacturing hydrophilic and adsorption resistant surfaces.

### Examples

In order that the invention described herein may be more fully understood, the following examples are set forth. The examples described in this application are offered to illustrate the compounds, compositions, materials, device, and methods provided herein and are not to be construed in any way as limiting their scope.

### Chemicals

Sylgard 184 silicone elastomer kit was purchased from Dow Corning (Tewksbury, MA). Monomethacryloxypropyl terminated polydimethylsiloxane (molecular weight: 5000 g/mol (70-80 cst), 800-1000 g/mol (7-9 cst), 600-800 g/mol (6-9 cSt)) (PDMSMA) was obtained from Gelest (Morrisville, PA). 2-Methacryloyloxyethyl phosphorylcholine (MPC), azobisisobutyronitrile (AIBN), deuterated methanol (MeOH), reactive red, vitamin b12, and 2-propanol were all received from Sigma Aldrich (St. Louis, MO). Fluorescently labeled protein, bovine serum albumin (BSA) (Alexa Fluor 594-labeled, BSA), was obtained from Thermo Fisher Scientific. Lysozyme (FITC-labeled) was purchased from Nanocs. BSA (from the chicken egg), lysozyme (from the chicken egg), vitamin B12, and reactive red were purchased from Sigma Aldrich. Acetonitrile (ACN), dimethylsulfoxide (DMSO), tetrahydrofuran (THF), methoxyphenol (MEHQ), and ethanol (EtOH) were sourced from Fisher Scientific (Hampton, NH). All chemicals and solvents were of reagent grade and used as received.

### Synthesis and Characterization of PDMS-r-MPC Copolymer

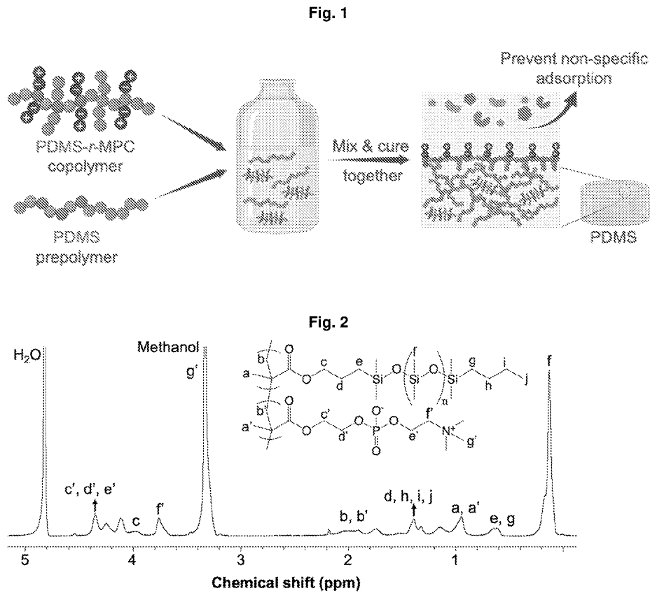

The random copolymer (CP) poly(polydimethylsiloxane-random-2-methacryloyloxyethyl phosphorylcholine) (PDMSMA-r-MPC) was synthesized using free radical polymerization (FIG. 2). First, monomethacryloxypropyl terminated polydimethylsiloxane (PDMSMA) was purified through a basic activated alumina column. Then, 2 g MPC was dissolved in 100 mL EtOH in a 250 mL round bottom flask at room temperature. Then 3 g PDMSMA was added to the reaction flask. 1 g of the initiator AIBN was added after dissolution. The reaction mixture was purged with nitrogen for 30 min. After the nitrogen purge, the reaction was stirred at 250 rpm for 20 hours in an oil bath at 65° C. At the end of this period, the flask was removed from the oil bath and the reaction was terminated by adding 0.25 g MEHQ. Then, the reaction mixture was poured into a 90/10 (v/v) ACN/water to precipitate out the copolymer, followed by three successive washes to eliminate any remaining unreacted monomer. The attained solid polymer was dried for two days under a fume hood and two more days in a vacuum oven at 50° C. The product yield was 58%, calculated from the ratio of the mass of the product copolymer to the mass of the monomers used. The chemical composition of the copolymer was measured by 1H NMR (Bruker Avance III 500 MHz spectrometer). Samples were dissolved in MeOH-d6 and scanned 32 times using a 10 s relaxation delay.

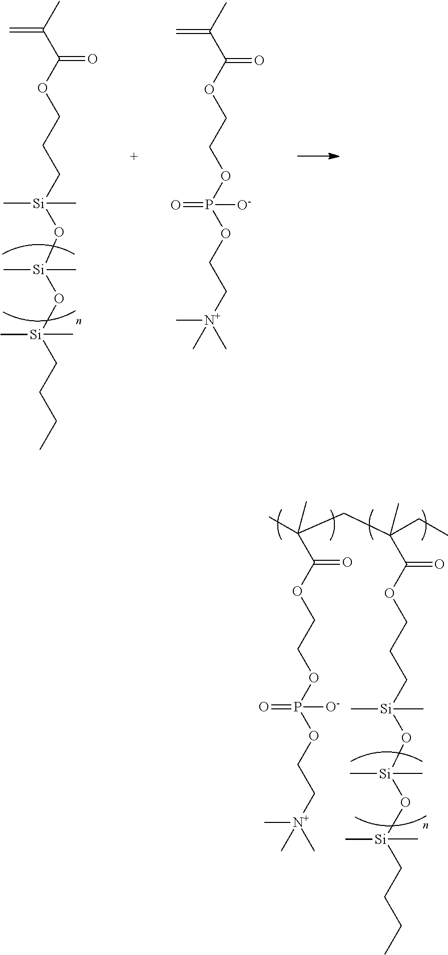

### Synthesis Scheme for the Random Zwitterionic PDMSMA-r-MPC Copolymer.

The CP's hydrodynamic diameter and relative molecular weight were measured by a dynamic light scattering (DLS) instrument (Brookhaven Instruments) equipped with a He—Ne laser operated at 659 nm and with a 1 mm entrance aperture at 25° C. and 90° angle. The PDMSMA-r-MPC CP was dissolved in EtOH (0.25 (w/v) %) and passed through a 0.45 μm Teflon syringe filter to eliminate impurities before analysis. The molecular weight of the PDMSMA-r-MPC copolymer is determined according to the Mark-Houwink equation. The equation parameters were K=0.012 mL/g and a: 0.68 at 25° C. in benzene.

Preparation of PDMS with PDMS-r-MPC Copolymer

Zwitterionic PDMSMA-r-MPC CP is dissolved in EtOH and utilized as an additive to modify PDMS. Silicone prepolymer and curing agent were mixed in 10:1 (w/w) ratio. The desired amount of PDMSMA-r-MPC CP was added to the polymer base-curing agent mix to reach a final additive concentration of 0.025%, 0.050%, 0.125%, and 0.250% (w/w) in the mixtures. The mixtures were blended thoroughly and poured into a petri dish to manufacture slabs for further experiments. Trapped air bubbles were removed by keeping the Petri dishes at 4° C. for 30 min. Then, the mixture was cured at 70° C. for 24 h.

Characterization of PDMS with and without PDMS-r-MPC Copolymer

### Surface Characterization

The surface wettability of PDMS samples with and without the CP additive at the polymer-air interface was evaluated by sessile drop water contact angle measurements (Rame-Hart Instrument Co., Netcong, NJ). 6 μL of distilled water (18.2 MΩ cm⁻¹ water) was dropped onto the (un) modified PDMS slabs (2 cm×2 cm). The contact angle was recorded at regular time intervals. PDMS without CP substrates (2 cm×2 cm) was used as a control. To characterize copolymer rearrangement at the surface, samples (1 cm×1 cm) were analyzed using X-ray photoelectron spectroscopy (XPS) (K-Alpha+XPS system (Thermo Scientific), Harvard University Center for Nanoscale Systems). An Aluminum k-X-ray line with an energy of 1.4866 keV and an X-ray spot size of 400 μm with a 90-degree take-off angle (sampling depth was roughly 10 nm from the surface) was used as the probe for the measurement. For sample surface charge compensation, a flood gun, which provides low-energy electrons and ions, was employed throughout the experiment. At each sample, survey spectra and high-resolution scan data were acquired. The scan was accomplished by averaging five scans in 1 eV increments with passing energy at 200 eV from −10 eV to 1350 eV binding energy for survey spectra. The data for high-resolution scans were collected by averaging 10 scans in 0.1 eV increments with passing energy at 50 eV for the Si 2p, O 1s, and C 1s photoelectron lines.

### Mechanical Properties

TA Instruments, RSA III Dynamic Mechanical Analyzer (DMA, Rheometrics Solids Analyzer) was used to assess the mechanical properties of modified and unmodified PDMS. Cylinder samples (4 mm dia, and 4 mm height) were produced according to ASTM specifications. The crosshead velocity for tensile testing was adjusted to 250 mm/min. At strain values below 15%, the linear behavior permits using Hooke's equation (E=σ/ε, where σ is the applied stress and ε is the resulting strain) to determine Young's modulus.

### Optical Properties

Optical clarity was measured using a UV-Vis spectrophotometer (Thermo Scientific, Genesis 10S equipped with a high-intensity xenon lamp and dual-beam optical geometry). PDMS and CP-modified PDMS samples (0.025-0.25 (w/w) %) were measured within the 400-600 nm wavelength range. All samples were manufactured with similar thicknesses (~8 mm) to eliminate discrepancies and were analyzed before and after IPA soaking.

### Gas Permeability

The gas permeability of PDMS and PDMS with PDMSMA-r-MPC CP membranes for CO₂ and O₂ was determined using previously reported methods. Tests were performed utilizing an in-line filter holder attached to a bubble flow meter under constant pressure at room temperature. Circular membranes with 12 mm diameter and 0.05-0.65 mm thicknesses were prepared and inserted into a stainless steel in-line filter holder (Cole Palmer). Membranes were supported with a porous metal mesh to prevent film distortion under the application of transmural gas pressure. The inlet was attached to a gas cylinder (O₂ or CO₂); the outlet fed to a capillary bubble flow meter. Feed pressure was controlled by a regulator and measured using a digital pressure gauge. At the beginning of each experiment, the feed gas was run until the entire system was purged, and the regulator was adjusted. The volumetric gas flow rate through the membrane was determined via the bubble flow meter, and permeability was calculated according to the previous report. Three samples (N=3) from different batches were used in each group.

### Adsorption and Absorption Characteristics of Blend PDMS Samples

PDMSMA-r-MPC CP at ratios between 0.025-0.250 (w/w %) was mixed with PDMS, poured into a petri dish, and polymerized at 70° C. for 24 h, as described in Section 2.3. After curing, PDMS samples (4 mm dia.×4 mm) were prepared using a 4 mm dermal punch (Ted Pella Inc.) and soaked in phosphate-buffered saline (PBS, pH 7.4) for two hours to equilibrate. Fluorescently labeled proteins, bovine serum albumin (BSA) (Alexa Fluor 594-labeled BSA, Thermo Fisher Scientific), and lysozyme (FITC-labeled, Nanocs) were dissolved separately in PBS to have a final concentration of 0.5 mg/mL. To investigate protein adsorption, 50 μL of fluorescently labeled protein solution was placed on each unmodified/modified PDMS sample and incubated in the dark at 37° C. for 1.5 h. After incubation, PDMS samples were washed off with PBS (500 μL) three times, and images were captured using a fluorescence microscope (Evos FL Imaging System, (ThermoFisher Scientific). Protein adsorption was then quantified using Image J.

Quantitative small molecule absorption experiments were also performed using PDMS slabs (4 mm dia.×4 mm) with/without CP additives. 5 μM aqueous solutions of vitamin B12 and reactive red was prepared separately. 200 μL of this solution was added into each well of 96 well plates. PDMS slabs with and without CP were introduced into the wells and are incubated for 2 hours at 37° C. The amounts of absorbed vitamin B12 and reactive red were calculated by measuring the initial and final concentration of each solute by a UV-vis spectrophotometer (Bio-rad spectrophotometer), using absorbances at 363 nm and 515 nm, respectively. In adsorption and absorption experiments, three samples (N=3) were used in each group.

### Statistical Analysis

Origin Pro 2021 Graphing & Analysis Software v.9.0.8.200 (Origin Lab, Northampton, Massachusetts) was used to analyze data. All quantitative data are presented as the mean±standard error of the mean (SEM) from at least three PDMS samples from different batches. The statistical significance of the results was assessed using one-way ANOVA. Statistical significance is defined as p<0.05 for all experiments.

### Synthesis, Design, and Screening of PDMSMA-r-MPC Copolymers

Most approaches to fabricating PDMS with improved fouling resistance involve modification of PDMS with different strategies such as surface activation, physisorption, and chemical modification^{2,3}. However, it is possible to fabricate PDMS with hydrophilic, adsorption/absorption resistant surfaces without any added manufacturing steps by blending zwitterionic random copolymers (ZI CPs) and following the standard protocol for preparation. While the preparation of PDMS with ZI CPs is simple, the design of CP requires thorough consideration and testing to ensure its success. PDMS devices are manufactured in the air, but PDMS surfaces are exposed to aqueous solutions in operation. Thus, CPs should segregate to surfaces during manufacture in air and have sufficient mobility to rearrange upon exposure to aqueous solutions, creating a hydrophilic surface that resists nonspecific adsorption/absorption. The polarity mismatch between PDMS and zwitterionic groups is a significant design challenge during the PDMS fabrication process. Thus, copolymer architecture can distinctly influence surface segregation and fouling resistance.

With those in mind, we designed and synthesized random copolymers of hydrophobic monomer, monomethacryloxypropyl terminated polydimethylsiloxane (PDMSMA), and the zwitterionic monomer, 2-methacryloyloxyethyl phosphorylcholine (MPC) by free radical polymerization (FIG. 2). We initially screened several ZI CPs to broadly explore the effect of the PDMS chain length and the PDMSMA/ZI segment ratio on surface segregation, surface properties, and nonspecific adsorption. PDMS side-chain length was varied by using PDMSMA monomers with different molecular weights (5000, 800-1000, 600-800 g/mol according to manufacturer). We also used varying PDMSMA/ZI monomer ratios (90/10, 80/20, 70/30, 60/40 by mass) (Table 1). After the synthesis, we dissolved the copolymer in a mutual/appropriate blending solvent and mixed it with PDMS prepolymer and curing agent at concentrations of 0.025, 0.050, 0.125, and 0.25 (w/w %). CPs synthesized with high MWs of PDMS monomer (5000, 800-1000 g/mol) resulted in i) low polymerization yield (~10-15%) (CP-1, CP-2, CP-3), ii) low solubility in blending solvent (CP-1, CP-3), iii) immiscible with PDMS and curing agent (CP-1, CP-3) and iv) almost the same hydrophobicity with unmodified PDMS (CP-2, CP-4). When mixed with PDMS, low transparency and bubble formation were also encountered after polymerization (CP-5).

TABLE 1
Molecular weights of PDMS monomers and
PDMS/MPC monomer mass ratios tested for
copolymer synthesis.

| CP | PDMSMA monomer | PDMSMA/MPC | Reaction |
|---|---|---|---|
| number | MW (g/mol) | monomer mass ratio | solvent |
| CP-1 | 5000 | 80/20 | DMSO |
| CP-2 | 800-1000 | 90/10 | THF + IPA |
| CP-3 | 800-1000 | 80/20 | Et-OH |
| CP-4 | 800-1000 | 60/40 | Et-OH |
| CP-5 | 600-800 | 90/10 | Et-OH |
| CP-6 | 600-800 | 80/20 | Et-OH |
| CP-7 | 600-800 | 70/30 | Et-OH |
| CP-8 | 600-800 | 60/40 | Et-OH |

DMSO: Dimethyl sulfoxide, THF: Tetrahydrofuran, IPA: Isopropyl alcohol, Et-OH: Ethanol

Besides, with a lower MW of PDMS monomer (600-800 g/mol), and a ZI monomer ratio above 10%, we achieved a relatively high polymerization yield (~60%). We could dissolve the copolymer and blend it in PDMS prepolymer without any problems like bubble formation and low transparency. Among all formulations, we achieved relatively low hydrophobicity with CB-6 and CB-7. CB-6 has slightly higher hydrophobicity (data will be discussed and shown in Section 3.2) and similar results in terms of surface characterization and nonspecific adsorption/absorption (data not shown) as CB-7; thus, in this paper, we have thoroughly evaluated and shown the hydrophilicity, surface characterization, and fouling resistance of CP-7.

The 1H NMR spectrum of the PDMS-r-MPC (CB-7) is given along with peak assignments (FIG. 2). The synthesized copolymer contained 46 (w/w %) MPC. Each MPC unit was associated with nine protons around 3.3 ppm′ (g′). The peaks around 3.7 ppm′ (c′, d′, e′) and 4.3 ppm′ (f′) were attributed to the CH₂ protons from MPC. The peak at 2.1 ppm (b) was assigned to the CH₂ protons from the PDMS polymer backbone, whereas the peak at 1.9 ppm′ (b′) was assigned to the CH₂ protons from the MPC polymer. The molecular weight of the CP-7 was estimated by dynamic light scattering (DLS) measurements in ethanol. The copolymer's hydrodynamic radius was determined to be 23.5 nm. The relative molecular weight of the copolymer was determined using the Mark-Houwink equation based on PDMS in toluene. While this is only a relative molar mass value indicative of coil size (somewhat similar to values reported for gel permeation chromatography when other calibrations are used), it suggests that long copolymer chains were formed.

### Surface Wettability and Stability of Blend PDMS Samples

Modified PDMS surface hydrophilicity was evaluated by water contact angle (WCA) measurements using the sessile drop method. We measured the WCA of un/modified samples dynamically to test our hypothesis that zwitterionic PDMSMA-r-MPC CP would decrease hydrophobicity with time and rests stably over long times.

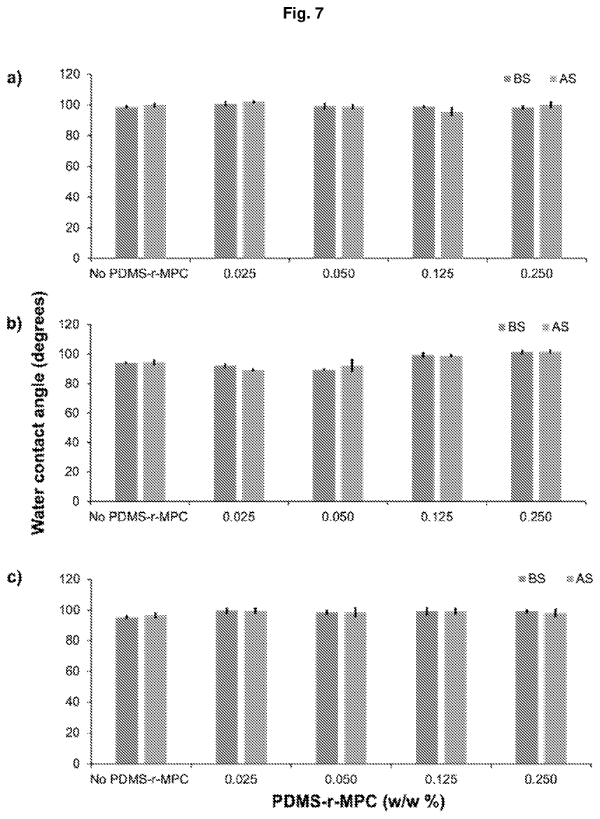

We first blended varying concentrations (0.025-0.25 w/w %) of CB-6, CB-7, and CB-8 in PDMS prepolymer and tested the effect of the PDMSMA/MPC CP ratio on the WCA of the modified samples. Fig. S1 shows the final WCA (t=45 min) of the PDMS with PDMSMA-r-MPC (0.025%-0.25 w/w %) before IPA soaking (BS) and after IPA soaking (AS). Varying concentrations of CB-6, CB-7, and CB-8 in PDMS bulk polymer did not create a significant decrease in WCA over time compared to unmodified PDMS (FIG. 7). However, although the WCA of PDMS with PDMSMA-r-MPC CP is high (around) 100°, modified PDMS samples significantly decreased protein and small molecule adsorption, which is discussed in Section 3.4. These results confirm the hypothesis that surfaces displaying molecular-scale heterogeneities in surface energy, such as random copolymers of highly hydrophilic and highly hydrophobic comonomers, can be hydrophobic yet still inhibit biofouling. Analytical methods such as water contact angle measurements cannot determine these heterogeneities since they appear over the length scale of the individual monomers.

To fabricate microfluidic devices for biomedical applications, specifically cell-based research, PDMS has to be sterilized with alcohol (i.e., IPA) and then treated with O₂ plasma and bonded to a glass or another piece of PDMS. Thus, in our experiments, we imitate the same steps for device fabrication. We first soaked the samples in IPA (samples labeled AS) and then treated them with O₂ plasma and kept the samples for one week (samples labeled AS+PT 1 wk). Then, we measured the WCA in each step (AS and AS+PT 1 wk) and investigated whether these treatments can create differences in the surface segregation of PDMSMA-r-MPC CP and, ultimately, in water contact angle and long-term stability.

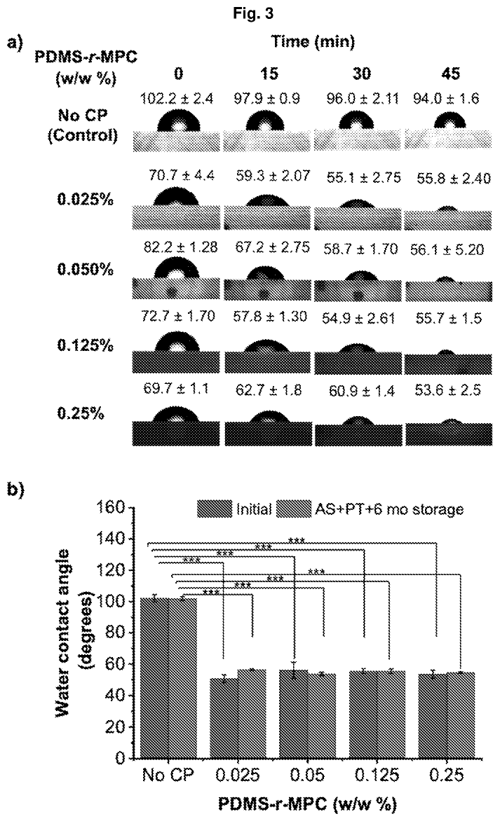

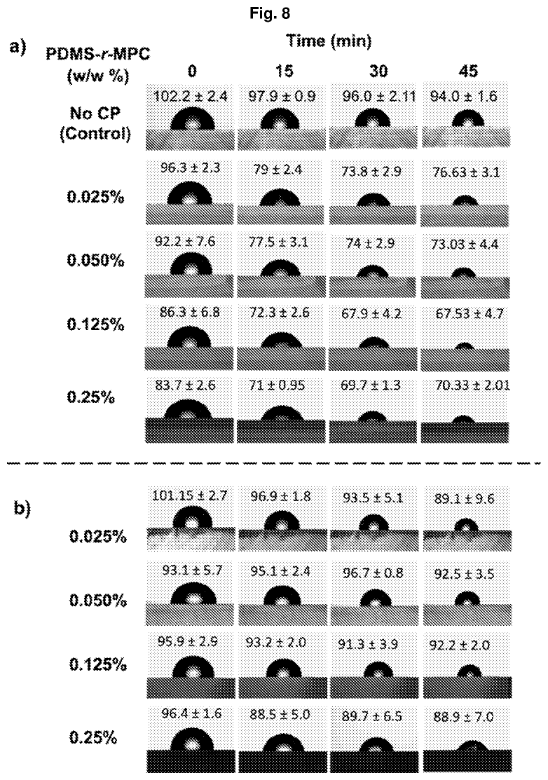

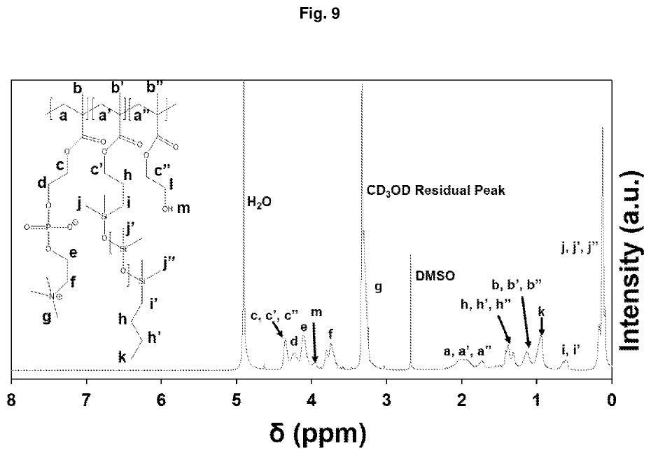

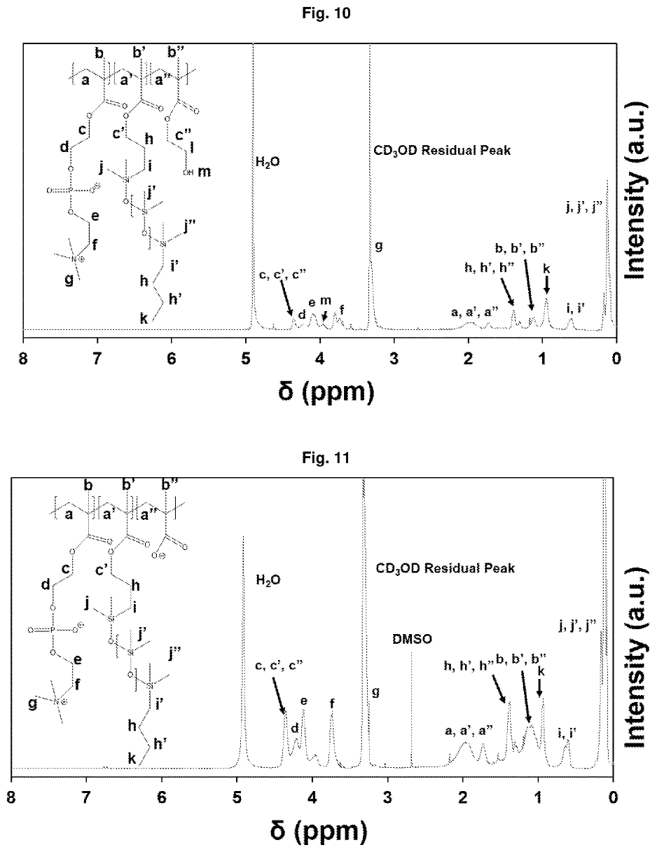

In a previous study, we had established that 24 h IPA soaking was enough to sterilize and remove all low molecular weight copolymers that might likely behave as cytotoxic surfactants, leaching out of the PDMS during experiments which could negatively affect cell viability.⁵³ Therefore, all samples were soaked in IPA for 24 hours. O₂ plasma is a required step for assembling microfluidic devices, and also a common method for generating reactive species that creates silanol groups on the PDMS surface and decreases hydrophobicity. However, the hydrophilicity of plasma-treated PDMS is not long-lasting. The surface returns to its initial hydrophobic state within a few days due to the reorientation of low molecular weight species from the bulk to the surface, which was also observed in our recent study. Nonetheless, we soaked our samples in IPA for 24 h and kept our samples for a week of plasma treatment (AS+PT 1 wk) for experimental practicality (FIG. 3A, FIG. 8).

FIG. 3A indicates the change of the WCA of PDMS samples prepared with different concentrations of PDMSMA-r-MPC CP (CB-7) in time after IPA soaking and one week after O₂ plasma. The initial contact angles of all samples were between 70-80°. This confirms that the sample surface is partially decorated with MPC segments even at the beginning. The WCA of unmodified PDMS remained constant above 90°, whereas the WCA of PDMS with PDMSMA-r-MPC CP decreased in time regardless of concentration for 45 minutes. Surfaces became considerably more hydrophilic compared to additive free PDMS. It should be noted that blending as little as 0.025% PDMSMA-r-MPC CP led to a final contact angle of 55.8° (FIG. 3A). These findings reveal that upon contact with water, the PDMSMA-r-MPC CP self-assembles and rearranges at the interface to form a hydrophilic zwitterionic layer even with a CP concentration of 0.025 (w/w %). In addition, this method can result in WCA values lower than previous studies for additive-modified PDMS materials, which range from 84° to 63°.^{54,55} We also followed the WCA of the un/modified PDMS samples over a 6-month duration. Moreover, the improved surface hydrophilicity of IPA-soaked & plasma-treated (AS+PT) samples was stable for at least six months (FIG. 3B). We also tested the WCA of CB-6 and CB-8 with varying concentrations (0.025-0.25%) after same treatments (FIG. 8). The final WCA (t=45 min) of CB-6 and CB-8 were higher than CB-7. Specifically, CB-8 had almost the same WCA as additive free PDMS (FIG. 8). This may be due to the low mass fraction of MPC in the CB-8 copolymer, which was insufficient to create hydrophilic surfaces.

The hydrophilic characteristic of PDMS with PDMSMA-r-MPC CP after plasma treatment can be explained with different hypotheses. Once the O₂ plasma attacks the siloxane backbone of modified PDMS, MPC groups likely interact with silanol (Si—OH) groups to form more hydrophilic and stable surfaces (6 months) than unmodified PDMS. Plasma treatment may have triggered and facilitated surface segregation of the PDMSMA-r-MPC CP by creating a driving force in a local gradient. Thus, the zwitterionic copolymer segregates to the surface before exposure to water. Our other hypothesis is that it may also be related to the complexity of competing etching, deposition, and crosslinking through plasma treatment. Plasma treatment etches PDMS repeat units which lead to losing methyl groups and creating silica on the surface. Moreover, plasma treatment may also result in crosslinking, but this impact is quite limited in PDMS.⁵⁶ Conversely, MPC is more likely to go through atomic rearrangement processes such as crosslinking instead of etching.⁵⁷ This demonstrates that methyl groups from PDMS chains may favorably etch during plasma treatment, exposing MPC segments immediately beneath. The plasma treatment can also crosslink the PDMS-r-MPC CP to the PDMS network chemically. In addition, it may result in the cross-linking of MPC chains on the surface. This may improve the durability of surface modification by anchoring the PDMS-r-MPC CP, particularly to the sample's top surface.

Having the lowest hydrophilicity among other zwitterionic copolymers (Table 1), we selected CB-7 to evaluate its physical properties and adsorption & absorption characteristic in PDMS bulk polymer thoroughly. We discussed these properties in the following sections.

### Physical Characterization of Blend PDMS Samples

### Surface Characterization

We checked the surface elemental composition of PDMS with 0.05% PDMS-r-MPC CP and unmodified PDMS using X-ray photoelectron spectroscopy (XPS). We assessed the surface atomic concentration of samples (O₁s, C1s, and Si2p) at each treatment stage (i.e., BS, AS, AS+PT) (Table 2). The XPS data did not detect any significant change in the surface composition after soaking in IPA. However, after plasma treatment, the carbon and oxygen content of the surface increased whereas the silicon content decreased in both unmodified PDMS and PDMS with 0.05% PDMSMA-r-MPC CP. However, after one week, the atomic compositions returned their initial values for unmodified PDMS. This is caused by the reorientation of silanol groups from the surface into the bulk PDMS and the movement of low molecular weight species (oligomers) from the bulk to the surface, eventually resulting in hydrophobic recovery. In contrast, PDMS with 0.05% PDMSMA-r-MPC retained its elemental composition even after one week of plasma treatment (Table 2). These results indicated the existence of zwitterionic MPC segments on the surface, which also corresponds well with the hydrophilicity data (Table 2, FIG. 3A)

TABLE 2
Elemental surface composition (atomic concentration, at %) of unmodified PDMS and
PDMS with 0.050 PDMSMA-r-MPC CP (w/w %) determined with XPS. Wide scan XPS
spectrum of samples tested before IPA soaking (BS), after IPA soaking (AS), after IPA soaking
and one day after plasma treatment (AS + PT-1 d), after IPA soaking, and 1 week after plasma
treatment (AS + PT-1 wk). PDMS/MPC (w/w %): 70/30. The scan was accomplished by
averaging 5 scans in 1 eV increments with passing energy at 200 eV from −10 eV to 1350 eV
binding energy for survey spectra.

| PDMSMA-r- | | | | |
|---|---|---|---|---|
| MPC (w/w %) | Treatments | O1s (at %) | C1s (at %) | Si2p (at %) |
| Control | BS | 27.80 | 45.16 | 27.04 |
| (Unmodified | AS | 27.85 | 44.99 | 26.16 |
| PDMS) | AS + PT-1 d | 40.59 | 32.37 | 27.04 |
| | AS + PT-1 wk | 27.79 | 45.34 | 26.87 |
| 0.05 % | BS | 28.02 | 44.92 | 27.06 |
| | AS | 28.00 | 45.14 | 26.85 |
| | AS + PT-1 d | 46.32 | 26.77 | 26.92 |
| | AS + PT-1 wk | 41.61 | 30.82 | 27.56 |

### Optical Clarity

Imaging cells and tracking their viability and motility with fluorescence microscopy is widely utilized in microfluidic applications. Thus, it is essential to use transparent materials to fabricate those devices. Greenlight [528-553 nm] excitation is excellent for imaging red fluorophores, while blue light [460-500 nm] excitation is frequently used to image green fluorescent protein (GFP) and Calcein AM.

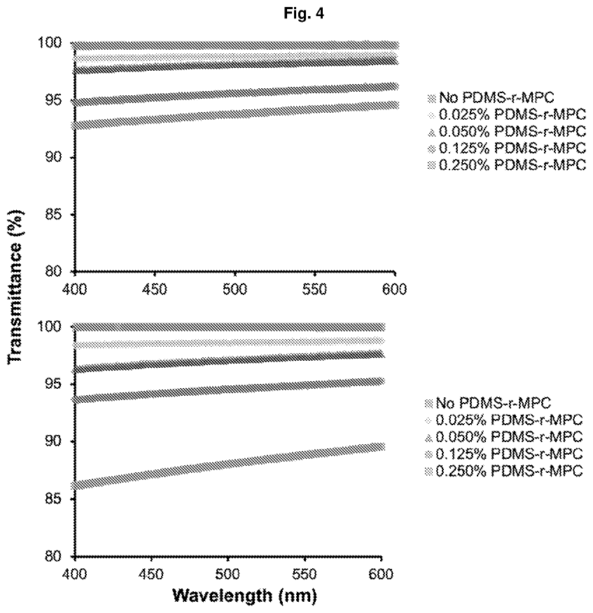

Hence, we tested the optical clarity of PDMS with and without PDMSMA-r-MPC CP by assessing light transmittance between 400-600 nm wavelengths in the UV-visible range before and after IPA soaking (FIG. 4). Transparency for the center wavelengths of blue light (480 nm) and green light (540 nm) is shown in Table 3. Before IPA soaking (FIG. 4),

TABLE 3
Transparency of the PDMS samples with PDMS-r-MPC
CPs at 450 and 540 nm.
PDMS: MPC (w/w %): 70/30. The data are the mean ± SE (n = 3).

| | Trans- | Trans- | Trans- | Trans- |
|---|---|---|---|---|
| PDMS-r- | mittance | mittance | mittance | mittance |
| MPC | @ 480 | @ 480 | @ 540 | @ 540 |
| (w/w %) | nm (BS) | nm (AS) | nm (BS) | nm (AS) |
| No Cp^{a} | 100 ± 0.1 | 100 ± 0.1 | 100 ± 0.1 | 100 ± 0.1 |
| No CP | 99.8 ± 0.002 | 100 ± 0.001 | 99.8 ± 0.002 | 100 ± 0.001 |
| 0.025 | 98.9 ± 0.001 | 98.6 ± 0.001 | 98.9 ± 0.001 | 98.7 ± 0.001 |
| 0.050 | 98.1 ± 0.004 | 97.0 ± 0.002 | 98.3 ± 0.004 | 97.3 ± 0.002 |
| 0.125 | 95.5 ± 0.005 | 94.4 ± 0.002 | 95.9 ± 0.005 | 94.8 ± 0.001 |
| 0.250 | 93.7 ± 0.002 | 84.0 ± 0.006 | 90.4 ± 0.002 | 85 ± 0.005 |

Blended samples up to 0.25% CP concentration have transparency values above 90%, comparable to additive free PDMS. After IPA soaking (FIG. 4), the optical clarity of blended samples slightly decreased but was still higher than 90% in the 0.025% to 0.125% CP range. Even with the highest CP concentration (0.25%), the transparency of PDMS samples is around 88%. This slight decrease is likely due to micelle formation by PDMSMA-r-MPC CP within the bulk PDMS at a higher concentration. Our results concluded that blending PDMS with zwitterionic copolymers did not affect the optical clarity of modified samples. So, PDMS with PDMS-r-MPC CP can easily be utilized in imaging during cell-based applications.

### Mechanical Properties

The high compliance and flexibility of PDMS one of its major advantages in microfluidics applications. The Young's modulus of a frequently used formulation, prepared with a prepolymer to curing agent ratio of 10:1, ranges from approximately ~1.63 to 2.12 MPa. Preserving these mechanical properties after modifications is important. We assessed the mechanical properties and Young's modulus of PDMS with PDMSMA-r-MPC CP with dynamic mechanical analysis (DMA) right after fabrication and after 6 months of storage. Young's modulus of PDMS with and without CP additive was calculated for the linear elastic region (<40% strain). Young's modulus of the modified samples at all additive concentrations was similar to additive free PDMS even after six months of storage, as desired.

### Gas Permeability

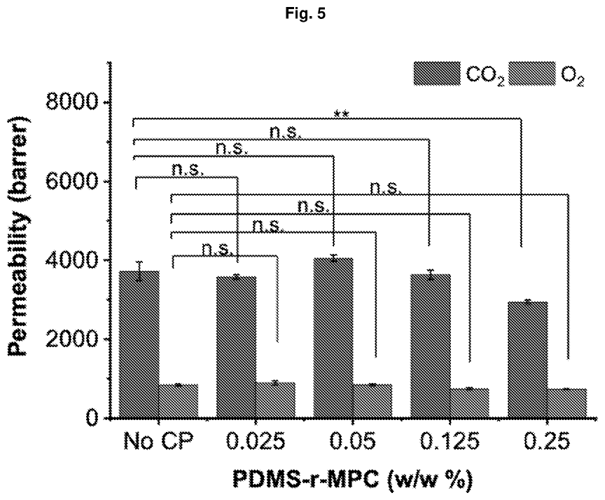

The gas permeability of PDMS is a significant benefit for cell culture applications since adequate oxygen (O₂), and carbon dioxide (CO₂) diffusion is required for the cells through the PDMS, particularly for long-term cultures (i.e., days to weeks). According to a previous report, O₂ and CO₂ permeability through PDMS is around 800 and 3800 Barrers, respectively, which is adequate for cell culture. We measured the gas permeability of PDMS with PDMSMA-r-MPC CP additives using previously reported methods. We did not observe significant differences in O₂ and CO₂ permeability of modified PDMS samples compared to the control (FIG. 5). The CO₂ permeability of PDMS with 0.25% PDMSMA-r-MPC CP additive is slightly lower (~3000 barrer) than additive free PDMS. This might result from the PDMSMA-r-MPC CP additive forming micelles or clumps within the bulk PDMS at higher concentrations. Our results indicate that modified PDMS samples preserve their permeability and are still applicable for microfluidic applications⁶⁰ with improved hydrophilicity.

### Adsorption & Absorption Characteristics of Blend PDMS Samples

One of the main drawbacks of PDMS is its inherent hydrophobicity which leads to the adsorption of significant quantities of proteins and the absorption of small molecules from the surrounding biological milieu. This problem changes the concentrations of solutes and complicates the analyses in microfluidics. The majority of undesirable bioreactions and bioresponses in artificial materials are facilitated by protein adsorption. Moreover, in many microfluidic applications, cells are exposed to a known concentration of particular proteins (i.e., drugs). However, the drug is lost through nonspecific adsorption, and cells are treated with a lower concentration than anticipated. This creates an underestimation in drug testing regarding activity and toxicity.

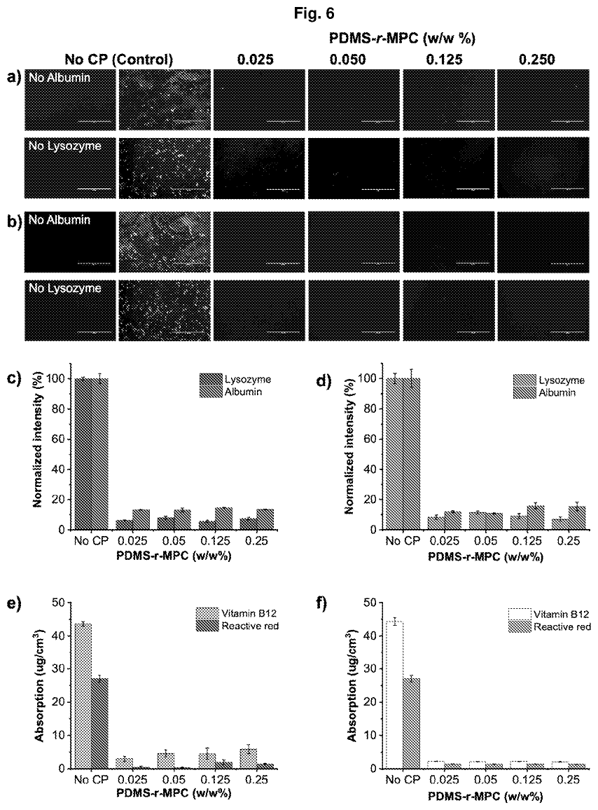

Our approach aims to prevent the nonspecific adsorption of proteins and small molecules using blended zwitterionic copolymers in bulk PDMS. We measured the adsorption of fluorescently labeled proteins (albumin and lysozyme) on PDMS slabs with and without PDMSMA-r-MPC CP (FIG. 6A, 6B) right after manufacturing (FIG. 6A) and after treatments that imitate biomicrofluidic device fabrication for biomedical applications (FIG. 6B, IPA soak and 1 week after O₂ plasma treatment). Fluorescent images showed that PDMS with PDMSMA-r-MPC additives (without any treatment) significantly reduced protein adsorption on the surface (FIG. 6A). We did not observe visible adsorption even using as low as 0.025% copolymer concentration. We obtained the same trend after IPA soaking and O₂ plasma treatment (FIG. 6B). Additive free PDMS slabs indicated considerably high protein adsorption compared to PDMS with PDMSMA-r-MPC CP, which was confirmed by the normalized intensity of albumin and lysozyme. (FIG. 6C, 6D). We also tested the absorption of vitamin B12 and reactive red using the pretreated and treated PDMS samples with and without PDMSMA-r-MPC CP (FIG. 6E, F). PDMS blended with CP—with and without treatment-drastically prevented vitamin B12 and reactive red absorption compared to additive free PDMS. Using only 0.025% PDMS-r-MPC CP additive, we lowered the adsorption of albumin and lysozyme, ~87% and ~93%, respectively, and absorption of vitamin B12 and reactive red ~93% compared to additive free PDMS without any treatment. After treatment of modified PDMS, the adsorption/absorption was suppressed ~88% for albumin, ~91% for lysozyme, ~93% for VB12, and ~95% for reactive red.

We want to point out that although the surface of modified PDMS samples without any treatment (no IPA soak and plasma treatment) is hydrophobic and very similar to unmodified PDMS, the surface can still resist protein adsorption. This concludes that surfaces involving small patches of hydrophilic and hydrophobic polymers may inhibit thermodynamically advantageous interactions between the foulant and the surface and thus can still resist nonspecific adsorption. As a result, the protein molecules can be considered surface nanoprobes that demonstrate the effects of a random copolymer with hydrophobic and hydrophilic monomeric units, which is also in accordance with previous reports.

### Synthesis and Characterization of PDMS MPC HEMA 60:30:10

To synthesize poly(polydimethylsiloxane methacrylate-random-methacryloyloxyethyl phosphocholine-random-hydroxylethyl methacrylate) (PDMSMA-r-MPC-r-HEMA). Initially, we purified the liquid hydrophobic monomers; hydroxyethyl methacrylate (HEMA) and polydimethylsiloxane methacrylate (PDMSMA), with a basic alumina column to remove excess inhibitor. Then in a 250 mL round bottom flask, we first added 1.5 g of the zwitterionic monomer, methacryloyloxyethyl phosphocholine (MPC), and 250 mL of denatured alcohol (by volume 90% ethanol, 5% methanol, and 5% isopropyl alcohol) as a solvent which we stirred while waiting for the MPC monomer to dissolve. Once dissolved, we added 3 g of PDMSMA to the reaction solution and 0.5 g of HEMA, which both dissolved immediately. We then added 1 g of azobisisobutyronitrile (AIBN) as a thermal initiator for the reaction. After capping with a rubber septum cap, we purged the reaction solution with 10 PSI of ultra-pure nitrogen for 30 mins while mixing the solution with a stir bar. After purging, we began the reaction by immersing the reaction flask in an oil bath at 68° C., during which we continuously stirred the reaction at 400 rpm. We allowed the reaction to proceed for 20 hours, at which point we removed the flask from the oil bath, exposed the solution to air, and added 0.25 g of 4-methoxy phenol (MEHQ) as a reaction terminator. To enhance precipitation, we rotovapped the solution to approximately 10 mL. We proceeded to precipitate the polymer in 250 mL of acetone, followed by three additional 95% acetone and 5% water washes for at least 8 hours each, during which we cut the polymer into smaller pieces. Once precipitated and washed, we removed the solid polymer pieces from the solution and allowed them to air dry in a fume hood to remove the bulk of the leftover solvents. Afterward, we transferred the solid polymer into a vacuum oven at 50° C. for 24 hours of additional drying. The yield of the polymer was approximately 20%. Composition of was determined by 1H NMR in deuterated methanol (CD₃OD).

### Synthesis and Characterization of PDMSMA-r-MPC-r-HEMA 60:20:20

To synthesize poly(polydimethylsiloxane methacrylate-random-methacryloyloxyethyl phosphocholine-random-hydroxylethyl methacrylate) (PDMSMA-r-MPC-r-HEMA). Initially, we purified the liquid hydrophobic monomers; hydroxyethyl methacrylate (HEMA) and polydimethylsiloxane methacrylate (PDMSMA), with a basic alumina column to remove excess inhibitor. Then in a 250 mL round bottom flask, we first added 1 g of the zwitterionic monomer, MPC, and 250 mL of denatured alcohol (by volume 90% ethanol, 5% methanol, and 5% isopropyl alcohol) as a solvent which we stirred while waiting for the MPC monomer to dissolve. Once dissolved, we added 3 g of PDMSMA to the reaction solution and 1 g of HEMA, which both dissolved immediately. We then added 1 g of azobisisobutyronitrile (AIBN) as a thermal initiator for the reaction. After capping with a rubber septum cap, we purged the reaction solution with 10 psi of ultra-pure nitrogen for 30 mins while mixing the solution with a stir bar. After purging, we began the reaction by immersing the reaction flask in an oil bath at 68° C., during which we continuously stirred the reaction at 400 rpm. We allowed the reaction to proceed for 20 hours, at which point we removed the flask from the oil bath, exposed the solution to air, and added 0.25 g of 4-methoxy phenol (MEHQ) as a reaction terminator. To enhance precipitation, we rotovapped the solution to approximately 10 mL. We proceeded to precipitate the polymer in 200 mL of 90 vol % acetone and 10 vol % water, followed by three additional 90 vol % acetone and 10 vol % water washes for at least 8 hours each, during which we cut the polymer into smaller pieces. Once precipitated and washed, we removed the solid polymer pieces from the solution and allowed them to air dry in a fume hood to remove the bulk of the leftover solvents. Afterward, we transferred the solid polymer into a vacuum oven at 50° C. for 24 hours of additional drying. The yield of the polymer was approximately 15%. Composition of was determined by 1H NMR in deuterated methanol (CD₃OD).

### Synthesis and Characterization of PDMS-r-MPC-r-MAA 60:30:10

To synthesize poly(polydimethylsiloxane methacrylate-random-methacryloyloxyethyl methacrylic acid) (PDMS-r-MPC-r-HAA). Initially, we purified the liquid hydrophobic monomers; methacrylic acid (MAA) with a neutral alumina column and poly(dimethylsiloxane) methacrylate (PDMSMA), with a basic alumina column to remove excess inhibitor. Then in a 250 mL round bottom flask, we first added 1.5 g of the zwitterionic monomer MPC, and 250 mL of denatured alcohol (by volume 90% ethanol, 5% methanol, and 5% isopropyl alcohol) as a solvent which we stirred while waiting for the MPC monomer to dissolve. Once dissolved, we added 3 g of PDMSMA to the reaction solution and 0.5 g of MAA, which both dissolved immediately. We then added 1 g of azobisisobutyronitrile (AIBN) as a thermal initiator for the reaction. After capping with a rubber septum cap, we purged the reaction solution with 10 psi of ultra-pure nitrogen for 30 mins while mixing the solution with a stir bar. After purging, we began the reaction by immersing the reaction flask in an oil bath at 68° C., during which we continuously stirred the reaction at 400 rpm. We allowed the reaction to proceed for 20 hours, at which point we removed the flask from the oil bath, exposed the solution to air, and added 0.50 g of 4-methoxy phenol (MEHQ) as a reaction terminator. To enhance precipitation, we rotovapped the solution to approximately 10 mL. We proceeded to precipitate the polymer in 300 mL of 90 vol % acetone and 10 vol % water, followed by three additional 90% acetone and 10% water washes for at least 8 hours each, during which we cut the polymer into smaller pieces. Once precipitated and washed, we removed the solid polymer pieces from the solution and allowed them to air dry in a fume hood to remove the bulk of the leftover solvents. Afterward, we transferred the solid polymer into a vacuum oven at 50° C. for 24 hours of additional drying. The yield of the polymer was approximately 34%. Composition of was determined by 1H NMR in deuterated methanol (CD₃OD).

### Measurement of Contact Angle

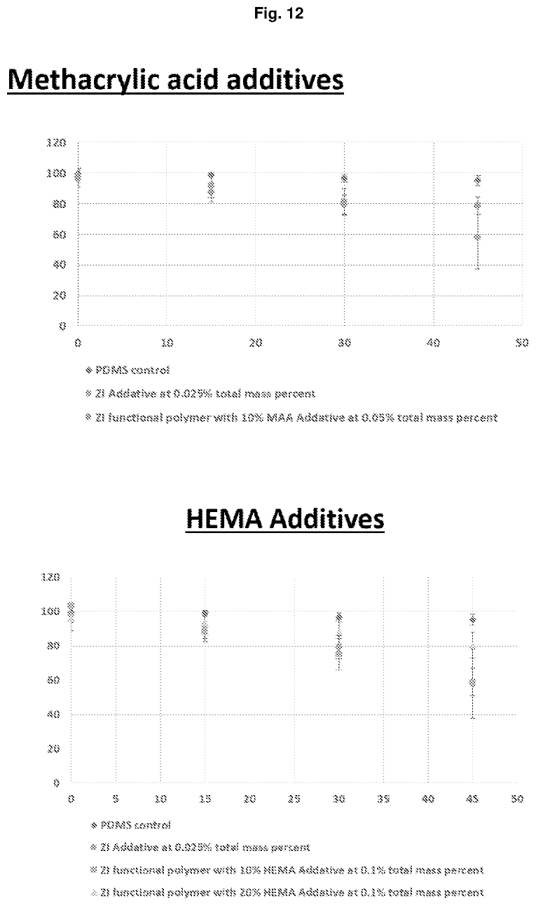

To show that the PDMS additives surface segregate we first dissolve the polymer additive into denatured alcohol (by volume 90% ethanol, 5% methanol, and 5% isopropyl alcohol) at a concentration of 1 g of polymer for 5 mL of solvent. Then we added the polymer solution at a desired amount into an uncured mixture of Gelest Sylgard-184 PDMS. We kept the PDMS and curing agent ratio at the standard 10:1 weight ratio. These samples were not soaked in IPA or plasma treated. To measure contact angle, 15 μL of DI water was placed on each sample. Results shown in FIG. 12.

### Congo Red Functionalization on HEMA Slabs

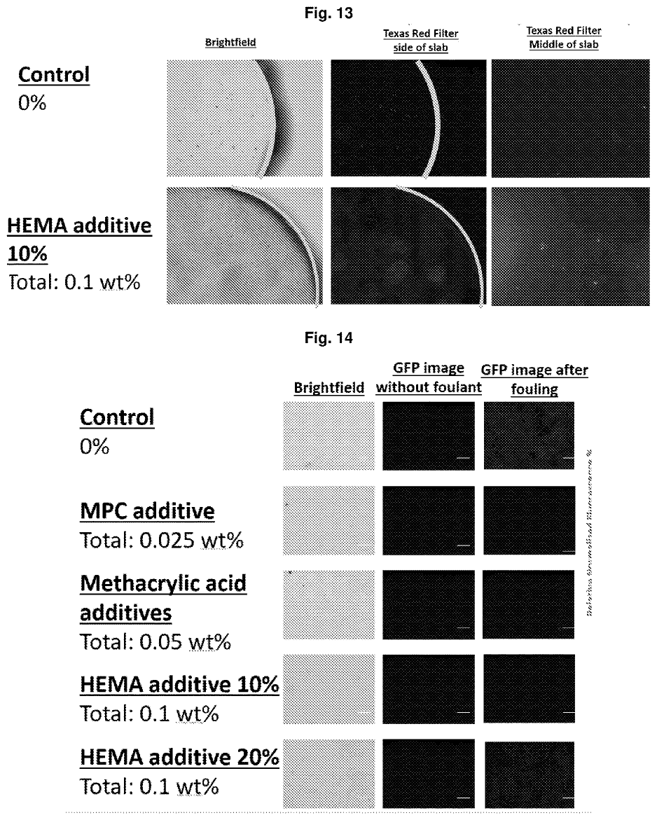

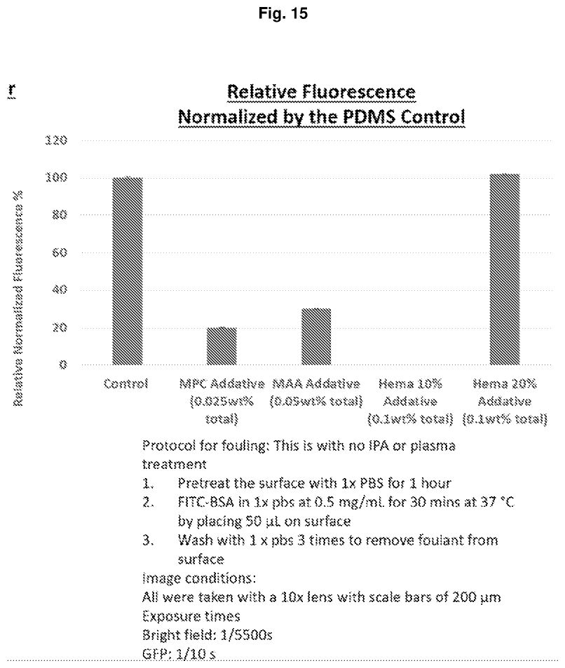

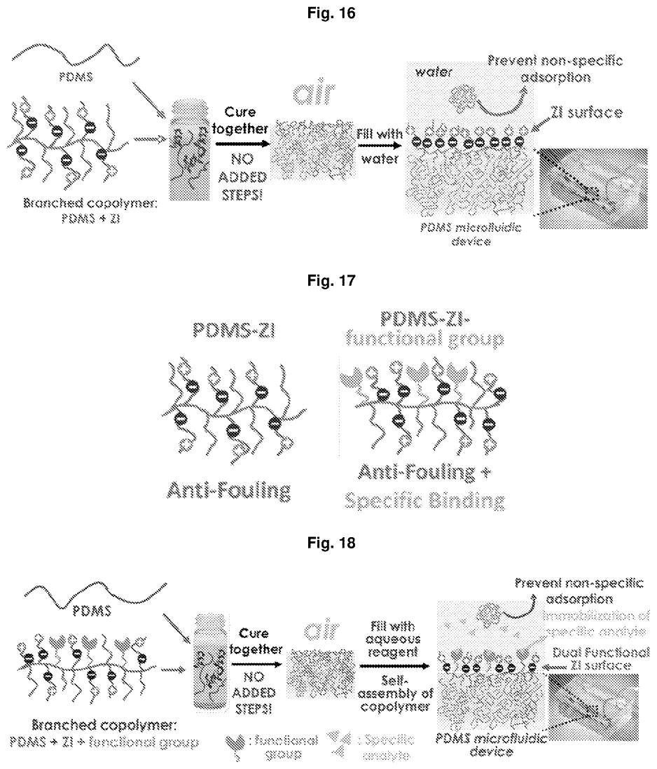

To demonstrate the functionalizability of PDMS samples blended with CPs with functionalizable groups, we selected PDMS slabs blended with PDMSMA-r-MPC-r-HEMA. These samples were exposed to a solution of toluene diisocyanate with a dibutyltin dilaurate catalyst in anhydrous DMSO for 30 minutes. 25 vol % of 10 mL total solution was the toluene diisocyanate, and contained 20 μL of catalyst. We expected that-OH groups on HEMA units would react with one side of the diisocyanates, thus creating isocyanate reactive groups on the surface. Then, the samples were immersed in a 1 mg/mL solution of Congo Red, a dye containing two —NH₂ groups that can react with isocyanates, for 30 minutes. Slabs were then washed with isopropanol for 24 hours. Samples were imaged in a fluorescence microscope using Texas Red filter, which showed areas where Congo Red was attached. All images were taken with a 4× lens, using an exposure time of 1/7500 s for bright field images and 1 s for fluorescence. These images are shown in FIG. 13, and they demonstrate the ability of these additives to adhere to desired functional groups through covalent reactions.

TABLE 4
Mechanical properties of PDMS samples with PDMSMA-r-MPC CPs.
PDMSMA:MPC (w/w %): 70/30.
The data are the mean ± SE (n = 3).

| PDMS-r-MPC | Young's modulus (MPa) | Young's modulus (MPa) |
|---|---|---|
| (w/w %) | (BS) | (6 months storage) |
| No Cp^{a} | 1.3 ± 0.1 | 1.3 ± 0.1 |
| No CP | 1.2 ± 0.10 | 1.3 ± 0.02 |
| 0.025 | 1.2 ± 0.03 | 1.1 ± 0.05 |
| 0.050 | 1.4 ± 0.02 | 1.3 ± 0.02 |
| 0.125 | 1.3 ± 0.02 | 1.4 ± 0.04 |
| 0.250 | 1.3 ± 0.10 | 1.4 ± 0.03 |

^{a}Young's modulus of PDMS from literature.
BS: Before IPA Soaking, AS: After IPA Soaking.

To conclude, with our approach, we created 1) hydrophobic and fouling-resistant resistant surfaces with modified PDMS samples without any treatment (no IPA soak & plasma treatment), 2) hydrophilic and fouling-resistant surfaces with modified PDMS samples after IPA soak and plasma treatment. This makes the modified PDMS samples more promising where the hydrophobic but protein/small molecule resistant surfaces are still desired.

We describe a simple method to improve the performance and reliability of PDMS by simply adding well-designed, highly branched zwitterionic PDMSMA-r-MPC CP into bulk PDMS for the first time. Through this, we created hydrophilic PDMS surfaces resistant to the fouling of proteins and small molecules for a wide range of microfluidic applications. Impressively, as little as 0.025% additive decreased contact angle as low as 55.8°±2.4°. PDMS surfaces preserved their hydrophilicity for at least 6 months, even after conventional manufacturing processes (e.g., soaking in IPA and plasma treatment). Using 0.025 (w/w %), PDMSMA-r-MPC CP decreased protein adsorption and small molecule absorption to ~93% and ~95%, comparable to or better than the highest reductions in the previous reports (ref). Furthermore, PDMS prepared with this approach preserve their transparency, flexibility, and gas permeability.

Unlike previous PDMS modification methods (coating/grafting), our method does not change PDMS microfabrication protocols by carefully designing the zwitterionic copolymers. Thus, this method is easy to scale up and compatible with large-scale manufacturing. We believe this method will positively alter the microfluidics research and industry landscape and improve the accessibility of micro-devices to end users (patients, researchers, industry) by providing a low-cost and user-friendly approach to fabricating reliable biomicrofluidics. Aside from microfluidic applications, we anticipate that our discovery will remove constraints that presently hinder the use of PDMS in crucial commercial applications such as those in the pharmaceutical and biomedical industries.

### INCORPORATION BY REFERENCE

All U.S. patents, and U.S. and PCT published patent applications cited herein are hereby incorporated by reference.

### EQUIVALENTS

The foregoing written specification is considered to be sufficient to enable one skilled in the art to practice the invention. The present invention is not to be limited in scope by examples provided, since the examples are intended as a single illustration of one aspect of the invention and other functionally equivalent embodiments are within the scope of the invention. Various modifications of the invention in addition to those shown and described herein will become apparent to those skilled in the art from the foregoing description and fall within the scope of the appended claims. The advantages and objects of the invention are not necessarily encompassed by each embodiment of the invention.

We claim:

1. A copolymer, comprising a plurality of zwitterionic repeat units, and a plurality of second repeat units; wherein each second repeat unit comprises a poly(dialkyl siloxane) pendant group.

2. The copolymer of claim 1, wherein each of the zwitterionic repeat units independently comprises sulfobetaine, carboxybetaine, phosphorylcholine, imidazolium alkyl sulfonate, or pyridinium alkyl sulfonate.

3. The copolymer of claim 1 or 2, wherein each of the zwitterionic repeat units is independently formed from sulfobetaine acrylate, sulfobetaine acrylamide, carboxybetaine acrylate, carboxybetaine methacrylate, 2-methacryloyloxyethyl phosphorylcholine, acryloxy phosphorylcholine, phosphorylcholine acrylamide, phosphorylcholine methacrylamide, carboxybetaine acrylamide, 3-(2-vinylpyridinium-1-yl) propane-1-sulfonate, 3-(4-vinylpyridinium-1-yl) propane-1-sulfonate, or sulfobetaine methacrylate.

4. The copolymer of any one of claims 1-3, wherein the copolymer is a statistical copolymer.

5. The copolymer of any one of the preceding claims, wherein the copolymer is not a block copolymer

6. The copolymer of any one of claims 1-5, wherein the copolymer is a branched copolymer.

7. The copolymer of any one of the preceding claims, wherein the polydialkylsiloxane is polydimethylsiloxane.

8. The copolymer of any one of the preceding claims, wherein each of the second repeat units independently comprises methacryate, acrylate, acrylamide, methacrylamide, or styrene.

9. The copolymer of any one of the preceding claims, wherein the second repeat units are monomethacryloxypropyl terminated polydimethylsiloxane.

10. The copolymer of any one of the preceding claims, wherein the copolymer is poly(polydimethylsiloxane monomethacrylate-random-2-methacryloyloxyethyl phosphorylcholine).

11. The copolymer of any one of the preceding claims, wherein the average molecular weight of the second repeat units is from about 300 g/mol to 30,000 g/mol.

12. The copolymer of any one of the preceding claims, wherein the average molecular weight of the second repeat units is from about 300 g/mol to 3000 g/mol.

13. The copolymer of any one of the preceding claims, wherein the average molecular weight of the repeat second units is from about 350 g/mol to 1200 g/mol.

14. The copolymer of any one of the preceding claims, wherein the zwitterionic repeat units constitute 10-50% by weight of the copolymer, and the second repeat units constitute 50-90% by weight of the copolymer.

15. The copolymer of any one of the preceding claims, wherein the zwitterionic repeat units constitute 20-40% by weight of the copolymer, and the second repeat units constitute 60-80% by weight of the copolymer.

16. The copolymer of any one of the preceding claims, wherein the zwitterionic repeat units constitute 20-30% by weight of the copolymer, and the second repeat units constitute 70-80% by weight of the copolymer.

17. The copolymer of any one of claims 1-13, further comprising a third repeat unit.

18. The copolymer of claim 17, wherein the third repeat unit comprises a reactive functional group.

19. The copolymer of claim 18, wherein the reactive functional group is an alcohol, carboxylic acid, or amine.

20. The copolymer of claim 19, wherein the third repeat unit is selected from methacrylic acid and hydroxyethyl methacrylate.

21. The copolymer of any one of claims 17-20, wherein the copolymer is poly(polydimethylsiloxane methacrylate-random-2-methacryloyloxyethyl phosphorylcholine-random-methacrylic acid) or poly(polydimethylsiloxane methacrylate-random-2-methacryloyloxyethyl phosphorylcholine-random-hydroxylethyl methacrylate).

22. The copolymer of any one of claims 17-21, wherein the zwitterionic repeat units constitute 20-40% by weight of the copolymer, the second repeat units constitute 50-70% by weight of the copolymer and the third repeat units constitute 10-20% by weight of the copolymer.

23. A sample of polydimethylsiloxane comprising the copolymer of any one of the preceding claims.

24. The sample of claim 21, wherein a surface of the sample has been treated with isopropyl alcohol (IPA).

25. The sample of claim 23 or 24, wherein a surface of the sample has been treated with an O₂ plasma.

26. The sample of any one of claims 23-25, wherein the copolymer constitutes 0.01-0.5% (w/w) of the sample.

27. The sample of any one of claims 23-26, wherein the copolymer constitutes 0.025-0.25% (w/w) of the sample.

28. A microfluidic device comprising the polydimethylsiloxane of any one of claims 23-27.
